(19) United States
(12) Patent Application Publication
(10) Pub. No.: US 2013/0268736 A1
(43) Pub. Date: Oct. 10, 2013

(54) SENSOR DATA RECORDING APPARATUS, METHOD, AND PROGRAM

(71) Applicant: KABUSHIKI KAISHA TOSHIBA, TOKYO (JP)

(72) Inventors: Masayuki OKAMOTO, Kawasaki-shi (JP); Takao MARUKAME, Yokohama-shi (JP); Kouji UENO, Kawasaki-shi (JP); Takahiro KURITA, Kawasaki-shi (JP); Atsuhiro KINOSHITA, Kamakura-shi (JP); Kenta CHO, Kawasaki-shi (JP)

(73) Assignee: KABUSHIKI KAISHA TOSHIBA, TOKYO (JP)

(21) Appl. No.: 13/856,604

(22) Filed: Apr. 4, 2013

(30) Foreign Application Priority Data
Apr. 6, 2012 (JP) 2012-087279

(51) Int. Cl. G06F 12/00

(52) U.S. Cl. CPC G06F 12/00
USPC 711/154

(57) ABSTRACT

According to one embodiment, a sensor data recording apparatus includes following elements. The temporary storage unit temporarily stores the sensor data acquired from sensors. The data selector selects sensor data stored in the temporary storage unit for each sensor. The sensor data storage unit stores the sensor data selected for each sensor. The recording method controller controls at least one of a recording method of storing the sensor data in the temporary storage unit, and a recording method of storing the sensor data in the sensor data storage unit, based on the recording status which is statistical information about storing of the sensor data in the sensor data storage unit.

### CROSS-REFERENCE TO RELATED APPLICATIONS

This application is based upon and claims the benefit of priority from Japanese Patent Application No. 2012-087279, filed Apr. 6, 2012, the entire contents of which are incorporated herein by reference.

### FIELD

Embodiments described herein relate generally to a sensor data recording apparatus, method, and program.

### BACKGROUND

The necessity is growing to continuously record data from a plurality of types of sensors by one terminal for a long period, like life recording using a personal terminal such as a personal computer (PC), mobile phone, smartphone, electronic tablet terminal, or clock, and environmental monitoring using a terminal installed outdoors. For example, a user carries a personal terminal with him and uses it in various locations. By recording data and terminal operations from a built-in sensor, a life log, which is the activity record of a user, can be accumulated. A terminal installed outdoors is used to provide agricultural support or check environmental pollution of the air, soil, and the like by collecting data from a built-in sensor. In recording using such a terminal, data must be recorded in detail for as long a time as possible.

Such a terminal is sometimes used in an environment where the power supply cannot always be used. For this reason, the terminal needs to reduce power consumption to record data for a long time even when the power supply cannot always be used.

### BRIEF DESCRIPTION OF THE DRAWINGS

FIG. 1 is a block diagram schematically showing a memory system according to an embodiment;

FIG. 2 is a block diagram schematically showing a sensor data recording apparatus according to the first embodiment;

FIG. 3 is a flowchart showing an example of the operation of the sensor data recording apparatus in FIG. 2;

FIG. 4 is a view for explaining a temporary storage unit shown in FIG. 2;

FIG. 5 is a view for explaining a data selector shown in FIG. 2; and

FIG. 6 is a block diagram schematically showing a sensor data recording apparatus according to the second embodiment.

### DETAILED DESCRIPTION

In general, according to one embodiment, a sensor data recording apparatus includes a data acquisition unit, a first temporary storage unit, a data selector, a sensor data storage unit, a recording status storage unit, and a recording method controller. The data acquisition unit is configured to acquire sensor data from a plurality of sensors. The first temporary storage unit is configured to temporarily store the sensor data in association with identification information representing a class of each of the sensors. The data selector is configured to select sensor data stored in the first temporary storage unit for each of the sensors in accordance with the identification information. The sensor data storage unit is configured to store the sensor data selected for each of the sensors. The recording status storage unit is configured to store, as a recording status, statistical information about storing of the sensor data in the sensor data storage unit. The recording method controller is configured to control at least one of a first recording method of storing the sensor data in the first temporary storage unit, and a second recording method of storing the sensor data in the sensor data storage unit, based on the recording status.

According to one embodiment, there is provides a sensor data recording apparatus, method, and program capable of reducing power consumption.

Hereinafter, a sensor data recording apparatus, method, and program according to an embodiment will be described with reference to the accompanying drawings. In the embodiments, like reference numbers denote like elements, and a repetitive description thereof will be omitted.

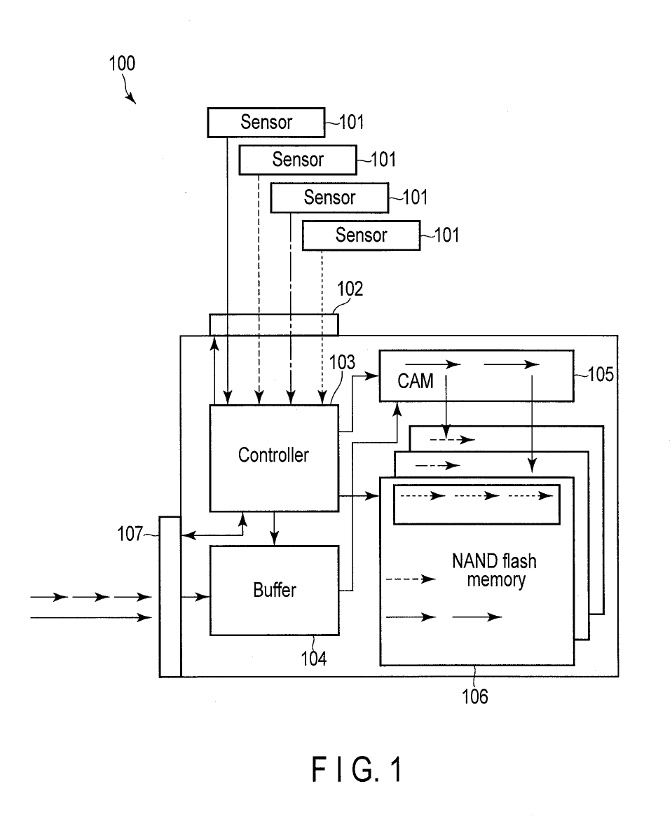

First, an example of a memory system to which a sensor data recording apparatus according to each embodiment to be described below is applied will be explained with reference to FIG. 1.

FIG. 1 schematically shows a memory system 100 according to an embodiment. The memory system 100 acquires sensor data from a plurality of (for example, four) sensors 101, and records them. The sensors 101 can be sensors of different types. Examples of the sensors include a Global Positioning System (GPS) receiver, acceleration sensor, geomagnetic sensor, illuminance sensor, temperature sensor, microphone, and radioactivity detector.

Specifically, the memory system 100 includes a sensor interface 102, controller 103, buffer 104, content addressable memory (CAM) 105, NAND flash memory 106, and host interface 107. The controller 103 controls the operations of the sensor interface 102, buffer 104, CAM 105, and NAND flash memory 106.

Sensor data generated by the respective sensors 101 are provided to the controller 103 via the sensor interface 102. The controller 103 stores the sensor data in the buffer 104. The buffer 104 temporarily stores the sensor data. The CAM 105 classifies the sensor data stored in the buffer 104 for the respective sensors, and stores them in the NAND flash memory 106. The NAND flash memory 106 includes a plurality of recording areas for the respective sensors 101. Sensor data from each sensor is written in a corresponding recording area. In this way, sensor data from the sensors 101 are finally recorded or stored in the NAND flash memory 106.

The host interface 107 is connected to a host device (for example, personal computer or mobile terminal: not shown), as needed. The host device exchanges data with the memory system 100 via the host interface 107. A sensor can also be arranged in the host device, and sensor data generated by this sensor is supplied to the memory system 100 via the host interface 107. The host device controls the controller 103 via the host interface 107. For example, the host device changes the control method of the controller 103. Further, the host device writes data to the NAND flash memory 106 via the controller 103, and reads data from the NAND flash memory 106.

Next, a sensor data recording apparatus according to the embodiment will be described.

### First Embodiment

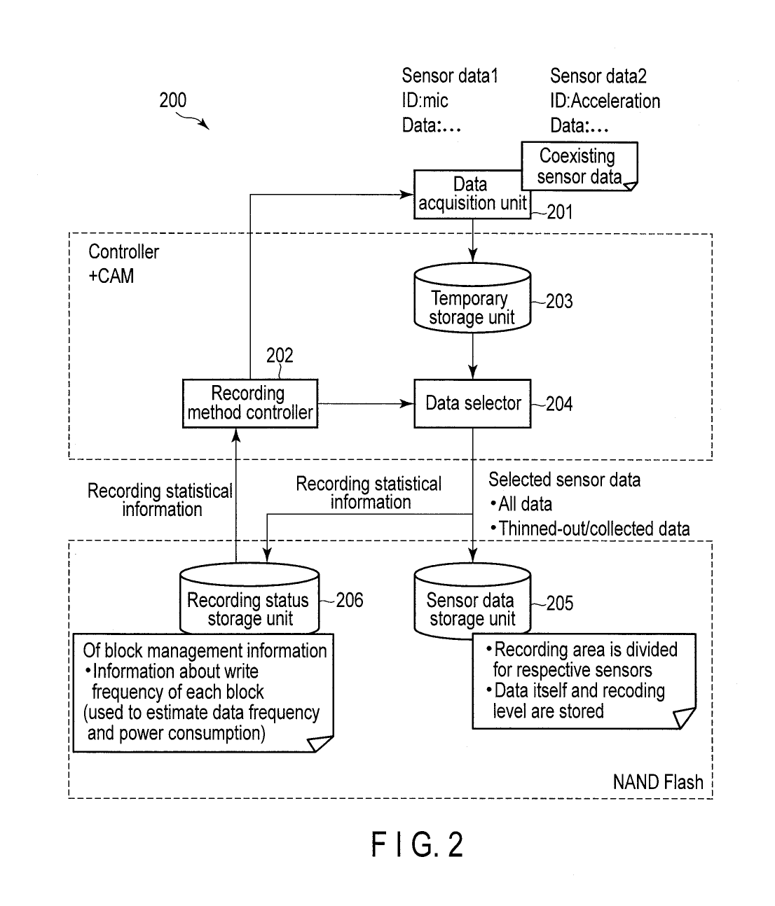

FIG. 2 schematically shows a sensor data recording apparatus 200 according to the first embodiment. The sensor data recording apparatus 200 includes a data acquisition unit 201, recording method controller 202, temporary storage unit 203, data selector 204, sensor data storage unit 205, and recording status storage unit 206. When the sensor data recording apparatus 200 is applied to a memory system 100, the data acquisition unit 201, recording method controller 202, temporary storage unit 203, and data selector 204 are implemented by a sensor interface 102, controller 103, buffer 104, and CAM 105, respectively. Further, the sensor data storage unit 205 and recording status storage unit 206 are implemented by a NAND flash memory 106.

The data acquisition unit 201 acquires sensor data from a plurality of sensors. The temporary storage unit 203 temporarily stores the sensor data acquired by the data acquisition unit 201. The temporary storage unit 203 records or stores sensor data in association with identification information (ID) representing a sensor class (or a sensor type).

The data selector 204 selects sensor data stored in the temporary storage unit 203 for each sensor, and stores the selected sensor data in the sensor data storage unit 205. The sensor data storage unit 205 includes a plurality of recording areas for the respective sensors. Each item of sensor data is recorded in a corresponding recording area. The data selector 204 generates statistical information about recording or storing of sensor data. This statistical information is stored as a recording status in the recording status storage unit 206. The statistical information includes, for example, the frequency of write. When a NAND flash memory is used as a recording medium, the statistical information includes the frequency of write for each block, the number of times of page write, and the number of times of page write per unit time. The statistical information can be generated for each sensor.

The recording method controller 202 controls at least one of the recording method of the data acquisition unit 201 and the recording method of the sensor data storage unit 205. For example, recording methods are set for respective sensors, and classified into a plurality of recording levels. By switching the recording method of the data acquisition unit 201, the recording method controller 202 can control an operation of recording or storing sensor data in the temporary storage unit 203 by the data acquisition unit 201. By switching the recording method of the data selector 204, the recording method controller 202 can control an operation of recording or storing sensor data in the sensor data storage unit 205 by the data selector 204. For example, the data selector 204 performs data thinning processing corresponding to a recording method designated by the recording method controller 202. Executing data thinning processing can reduce the amount of data to be recorded and thus reduce power used in data recording.

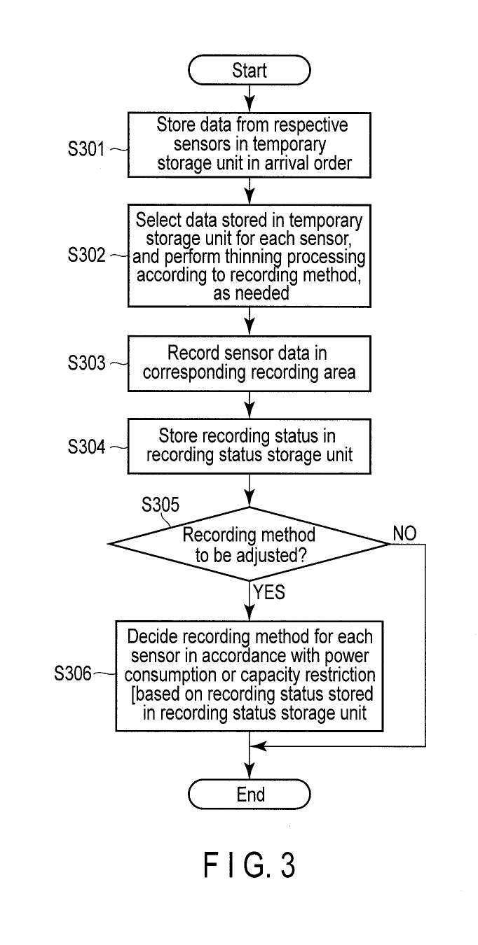

FIG. 3 shows an example of the operation of the sensor data recording apparatus 200. More specifically, FIG. 3 shows sensor data recording processing per unit time in the sensor data recording apparatus 200. In step S301 of FIG. 3, the data acquisition unit 201 sequentially acquires sensor data from a plurality of sensors, and records them in the temporary storage unit 203 in the acquisition order according to the recording method.

In step S302, the data selector 204 selects sensor data for each sensor from the sensor data recorded in the temporary storage unit 203. In step S303, the data selector 204 records the sensor data selected for each sensor in the sensor data storage unit 205 according to the recording method. In the sensor data storage unit 205, sensor data from each sensor is recorded in a corresponding recording area. The processing of step S302 and that of step S303 are executed, for example, at a predetermined time interval. Also, the processing of step S302 and that of step S303 can be executed when the amount of sensor data recorded in the temporary storage unit 203 exceeds a predetermined threshold.

In step S304, the data selector 204 generates statistical information about data recording, and records it as a recording status in the recording status storage unit 206. In step S305, the recording method controller 202 determines whether to switch (or adjust) at least one of the recording method of the data acquisition unit 201 and the recording method of the sensor data storage unit 205. The timing when the recording method controller 202 executes the processing of determining whether to switch the recording method can be based on the total number of times of page write, the total data recording amount, the lapse of time, a change of the remaining battery level of the memory system, or the like. For example, every time a predetermined time elapses, the recording method controller 202 determines whether to switch the recording method.

For example, when the remaining battery level of the memory system becomes lower than a predetermined threshold, the recording method controller 202 determines to switch the recording method. When switching the recording method, the process advances to step S306; otherwise, ends. In step S306, the recording method controller 202 reads a recording status stored in the recording status storage unit 206, and switches the recording method based on the recording status. For example, the recording method controller 202 estimates a remaining battery level based on the recording status, and determines a recording method for each sensor in accordance with the remaining battery level. By adjusting at least one of the recording method of the data acquisition unit 201 and that of the data selector 204 based on the recording status, the sensor data recording apparatus 200 can reduce power consumption and record sensor data for a long period.

In another example, the recording method controller 202 determines a recording method for each sensor in accordance with the free area of the sensor data storage unit 205. When the free area of the sensor data storage unit 205 becomes small, the amount of data to be thinned out is increased to prevent a failure to record sensor data in the sensor data storage unit 205 due to a capacity shortage. Sensor data can therefore be recorded for a long period.

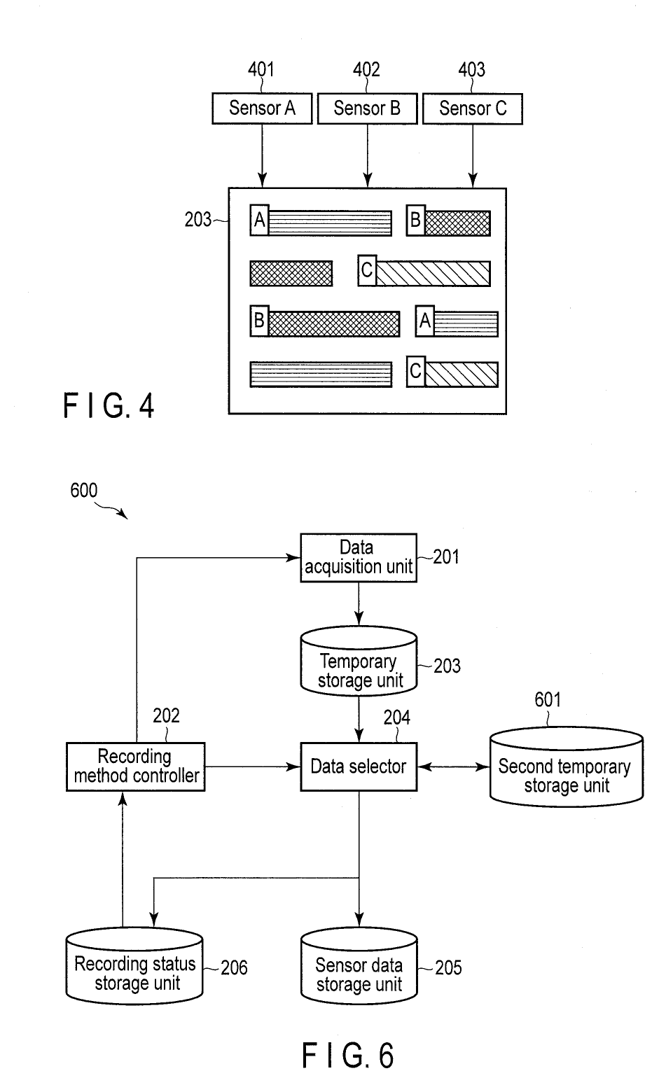

Next, the processing in step S301 of FIG. 3 will be concretely described with reference to FIG. 4. FIG. 4 shows an example in which sensor data generated by three sensors 401, 402, and 403 are recorded in the temporary storage unit 203. In the example of FIG. 4, the data acquisition unit 201 acquires sensor data in the order of the sensor 401, sensor 402, sensor 403, sensor 402, sensor 401, and sensor 403. The sensor data are recorded in the temporary storage unit 203 in this order. In the temporary storage unit 203, the sensor data are recorded in time series in association with IDs (A, B, and C in FIG. 4) each indicating a sensor class. Note that sensor data may be recorded in association with the time when it is recorded in the temporary storage unit 203, and the recording method (or recording level). The frequency at which sensor data is generated, the amount of sensor data, and the like differ between sensors.

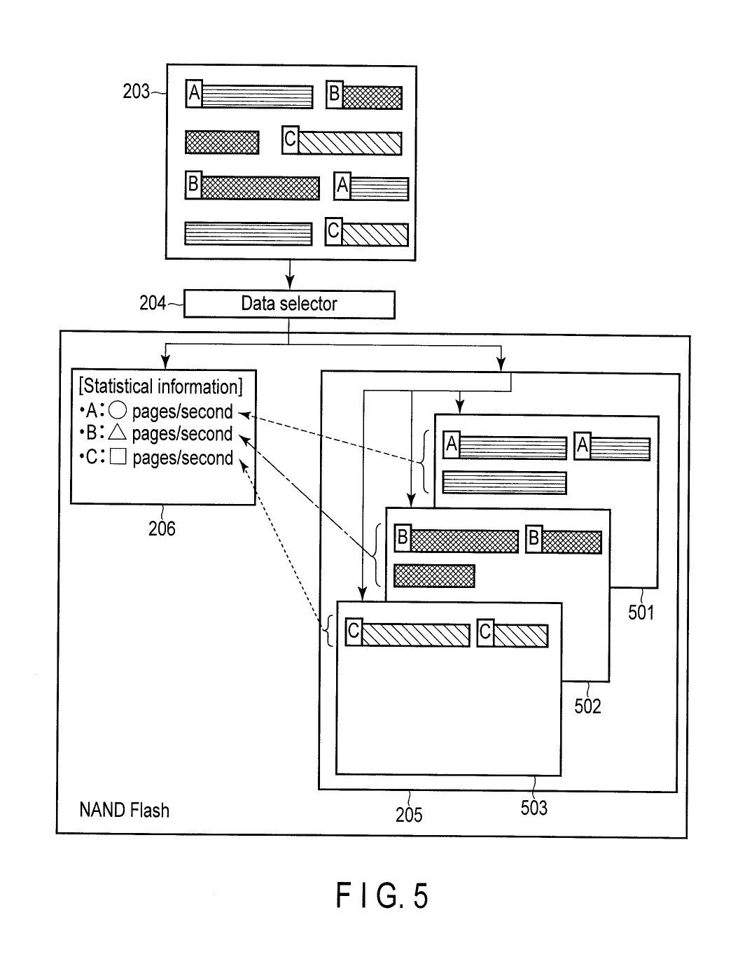

The processes in steps S302 to S304 of FIG. 3 will be concretely described with reference to FIG. 5. The data selector 204 extracts sensor data from the temporary storage unit 203 selectively for the respective sensors, and records them in the sensor data storage unit 205. In the example of FIG. 5, there are three types of sensors A, B, and C. Thus, the data selector 204 performs the data selection operation three times. The data selector 204 additionally writes sensor data of sensor A in a recording area 501 for the sensor A in the sensor data storage unit 205, additionally writes sensor data of sensor B in a recording area 502 for the sensor B in the sensor data storage unit 205, and additionally writes sensor data of sensor C in a recording area 503 for the sensor C in the sensor data storage unit 205. Further, the data selector 204 generates statistical information about recording of sensor data in the sensor data storage unit 205, and records it as a recording status in the recording status storage unit 206. As a write address, an expression of a physical address is used for descriptive convenience in FIG. 5, but a logical address obtained by conversion may be used. In this case, the controller 103 in FIG. 1 is implemented using a logical address.

The processes in steps S305 and S306 of FIG. 3 will be concretely described.

For example, the recording method controller 202 changes the recording method in accordance with the remaining battery level of the memory system. The remaining battery level may be acquired as sensor data from a sensor, from a host device via the host interface 107, or directly by the controller 103. Alternatively, the remaining battery level of the memory system may be estimated from power consumption of each sensor. Power consumption of each sensor per unit time may be acquired as sensor data from the sensor, from a host device via the host interface 107, or directly by the controller 103. Power consumption of each sensor can also be estimated from the recording status. For example, when a NAND flash memory is used as a recording medium, power consumption of each sensor can be estimated from the number of times of page write recorded for the sensor. When a sensor generates sensor data at almost the same frequency and timing, power consumption of the sensor can be estimated from a sensor data distribution in the temporary storage unit 203, instead of the recording status. The sensor data distribution is a distribution representing the ratio of the sensor data amount of each sensor to the sensor data amount recorded in the temporary storage unit 203. For example, obtained from the temporary storage unit 203 is a sensor data distribution representing that the ratio of the sensor data amount of sensor A to the total sensor data amount is 30% in the temporary storage unit 203, that of the sensor data amount of sensor B to the total sensor data amount is 40%, and that of the sensor data amount of sensor C to the total sensor data amount is 30%.

The recording method controller 202 can estimate power consumption of each sensor using one or more methods among the above-described methods and other methods, and can estimate the remaining battery level of the memory system based on the estimation result. When the estimated remaining battery level is lower than a predetermined threshold, the recording method controller 202 switches the recording level of the recording method or sets the initial value of the recording method. For example, two thresholds (first threshold and second threshold smaller than the first threshold) are prepared, and three recording levels are prepared. A method which does not thin out data is defined as recording level 1, and a method which thins out data by a larger amount than that at recording level 2 is defined as recording level 3. In this case, when the remaining battery level is greater than or equal to the first threshold, the recording method is set to recording level 1. If the remaining battery level becomes lower than the first threshold and greater than or equal to the second threshold, the recording method is switched to recording level 2. If the remaining battery level becomes lower than the second threshold, the recording method is switched to recording level 3.

In another example, the recording method controller 202 adjusts the recording method in accordance with a sensor data recording amount representing the amount of sensor data recorded in the sensor data storage unit 205. More specifically, the recording method controller 202 calculates a sensor data recording amount per unit time. When the sensor data recording amount exceeds a predetermined threshold, the recording method controller 202 switches the recording method. In still another example, when the remaining time during which sensor data can be written in the sensor data storage unit 205 becomes shorter than a predetermined threshold, the recording method controller 202 switches the recording method.

Next, a method of reducing the amount of data to be recorded will be explained in detail.

The present embodiment switches the recording level of the recording method to reduce the amount of data to be recorded. For example, the recording level is designated by a threshold for determining whether to record (or store) data. For example, when the sensor is a microphone, the threshold for determining whether to record data corresponds to volume. In this example, when sound in sensor data has a predetermined volume (threshold) or more, the sensor data is recorded. By changing the threshold for determining whether to record data, the amount of data to be recorded can be reduced.

In another example, the recording level is designated by a time interval at which data is recorded (or stored). When the time interval at which data is recorded is shortened, data recording is executed intermittently, the sampling rate is decreased, or data recording is suspended for a predetermined time. For example, a time interval at which sensor data is recorded, and a time interval at which no sensor data is recorded are alternately set. By shortening the time interval at which data is recorded, the amount of data to be recorded can be reduced.

In still another example, the recording level is designated by the resolution. For example, when the sensor is a microphone, the resolution corresponds to the quantization bit rate. By decreasing the resolution, the amount of data to be recorded can be reduced. In still another example, the recording level is used to change the quality of information to be recorded. When this recording level is set, the data acquisition unit 201 records, for example, input of sensor data and does not record concrete sensor data.

By using one or more recording levels among the above-described recording levels and other recording levels, the amount of data to be recorded can be controlled. Further, sensor data is stored in the sensor data storage unit 205 in association with the recording level together with the sensor class. This allows grasping a recording state when reading data later.

By switching the recording method (recording level), sensor data recording can be controlled in accordance with the use situation. Further, the present embodiment is available to absorb data fluctuations arising from the difference in sensor model or the individual difference of a sensor. Even sensors of the same type differ between devices in the frequency and data amount of generated sensor data. For example, when acquiring sensor data from an acceleration sensor, a sensor available from company A may acquire 20 items of numerical data each of 32 bits per second, and a sensor available from company B may acquire 40 items of numerical data each of 64 bits per second. Even among sensors available from company A, a device which generates 20 items of data per second and a device which generates 25 items of data per second coexist. In this manner, the frequency and size of generated data may change due to an individual difference. However, the embodiment can acquire 20 items of sensor data per second and unify the data size to 32 bits without confirming a difference between sensors or making an adjustment.

As described above, the sensor data recording apparatus according to the first embodiment can reduce power consumption by switching the recording method in accordance with the remaining battery level. Even when the power supply cannot always be used, sensor data can be recorded for a long period.

### Second Embodiment

When sensor data selected by the data selector 204 is immediately stored in the sensor data storage unit 205, as in the first embodiment, power consumption increases or the recording efficiency decreases in some cases. For example, when sensor data having a small data size are acquired at a low frequency, sensor data of a size smaller than the page size of a NAND flash memory may be recorded. In this case, the recording efficiency drops, and power consumption per data of a unit size increases. To solve this, in the second embodiment, items of sensor data are temporarily accumulated until they reach a minimum recording unit (page size), and when they reach the minimum recording unit, the items of sensor data are recorded in a sensor data storage unit 205.

FIG. 6 schematically shows a sensor data recording apparatus 600 according to the second embodiment. The sensor data recording apparatus 600 in FIG. 6 includes a second temporary storage unit 601 in addition to the arrangement of a sensor data recording apparatus 200 in FIG. 2. When recording data does not reach a page size, a data selector 204 stores the sensor data in the second temporary storage unit 601. Sensor data stored in the second temporary storage unit 601 are read when they reach the page size, and then are recorded in the sensor data storage unit 205. An operation except for the operation of recording sensor data in the sensor data storage unit 205 by the data selector 204 is the same as that in the first embodiment, and a description thereof will not be repeated.

As described above, the sensor data recording apparatus according to the second embodiment includes the second temporary storage unit which temporarily records data until sensor data reach the page size, and thus can increase the recording efficiency and further reduce power consumption.

The processing described in each of the above embodiments can be executed by a storage using an existing NAND flash memory, a sensor data input circuit, and the like. Therefore, the sensor data recording apparatus can be implemented by a device which saves power consumed by OS processing (using the CPU and DRAM).

The sensor data recording apparatus in each of the above embodiments may be implemented as a single apparatus. Alternatively, the sensor data recording apparatus can be implemented in a general computer including a control device such as a CPU, storage devices such as a ROM and RAM, an external storage device such as an HDD, a display device such as a display, and input devices such as a keyboard and mouse.

In above example, each functional block of the sensor data recording apparatus in each of the above embodiments is implemented by the memory system 100. However, some blocks may be arranged on the host side to communicate data with the memory system 100 via the host interface 107. In the embodiment, the data selector 204 is implemented by the CAM 105. However, the CAM 105 may be a generally used CAM, or may be implemented by the page buffer of the NAND flash memory 106 or the buffer 104. Alternatively, the data selector 204 may be implemented by another device capable of selecting data.

A program which implements the processing in each of the above embodiments can be provided by storing it in a computer-readable storage medium. The storage format of the storage medium is arbitrary as long as the storage medium can store a program and is readable by a computer, such as a magnetic disk, optical disk (for example, CD-ROM, CD-R, or DVD), magneto-optical disk (for example, MO), or semiconductor memory.

Also, the program which implements the processing in each of the above embodiments may be stored in a computer (server) connected to a network such as the Internet, and downloaded to a computer (client) via the network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sensor data recording apparatus comprising:
a data acquisition unit configured to acquire sensor data from a plurality of sensors;
a first temporary storage unit configured to temporarily store the sensor data in association with identification information representing a class of each of the sensors;
a data selector configured to select sensor data stored in the first temporary storage unit for each of the sensors in accordance with the identification information;
a sensor data storage unit configured to store the sensor data selected for each of the sensors;
a recording status storage unit configured to store, as a recording status, statistical information about storing of the sensor data in the sensor data storage unit; and
a recording method controller configured to control at least one of a first recording method of storing the sensor data in the first temporary storage unit, and a second recording method of storing the sensor data in the sensor data storage unit, based on the recording status.

2. The apparatus according to claim 1, wherein the recording method controller sets the at least one of the first recording method and the second recording method for each of the sensors based on a distribution of the sensor data stored in the first temporary storage unit.

3. The apparatus according to claim 1, wherein the at least one of the first recording method and the second recording method is designated by one of a threshold for determining whether to store data, a time interval at which data is stored, and a resolution.

4. The apparatus according to claim 1, further comprising a second temporary storage unit configured to temporarily store the sensor data selected for each of the sensors until the sensor data reaches a minimum recording unit of the sensor data storage unit.

5. The apparatus according to claim 1, wherein the sensor data storage unit includes a plurality of recording areas for the respective sensors.

6. A sensor data recording method comprising:
acquiring sensor data from a plurality of sensors;
temporarily storing the sensor data in a first temporary storage unit in association with identification information representing a class of each of the sensors;
selecting sensor data stored in the first temporary storage unit for each of the sensors in accordance with the identification information;
storing the sensor data selected for each of the sensors in a sensor data storage unit;
storing, as a recording status, statistical information about storing of the sensor data in the sensor data storage unit; and
controlling at least one of a first recording method of storing the sensor data in the first temporary storage unit, and a second recording method of storing the sensor data in the sensor data storage unit, based on the recording status.

7. The method according to claim 6, wherein the controlling at least one of the first recording method and the second recording method comprising setting the at least one of the first recording method and the second recording method for each of the sensors based on a distribution of the sensor data stored in the first temporary storage unit.

8. The method according to claim 6, wherein the at least one of the first recording method and the second recording method is designated by one of a threshold for determining whether to store data, a time interval at which data is stored, and a resolution.

9. The method according to claim 6, further comprising temporarily storing the sensor data selected for each of the sensors in a second temporary storage unit until the sensor data reaches a minimum recording unit of the sensor data storage unit.

10. The method according to claim 6, wherein the sensor data storage unit includes a plurality of recording areas for the respective sensors.

11. A non-transitory computer readable medium including computer executable instructions, wherein the instructions, when executed by a processor, cause the processor to perform a method comprising:
acquiring sensor data from a plurality of sensors;
temporarily storing the sensor data in a first temporary storage unit in association with identification information representing a class of each of the sensors;
selecting sensor data stored in the first temporary storage unit for each of the sensors in accordance with the identification information;
storing the sensor data selected for each of the sensors in a sensor data storage unit;
storing, as a recording status, statistical information about storing of the sensor data in the sensor data storage unit; and
controlling at least one of a first recording method of storing the sensor data in the first temporary storage unit, and a second recording method of storing the sensor data in the sensor data storage unit, based on the recording status.

12. The medium according to claim 11, wherein the controlling at least one of the first recording method and the second recording method comprising setting the at least one of the first recording method and the second recording method for each of the sensors based on a distribution of the sensor data stored in the first temporary storage unit.

13. The medium according to claim 11, wherein the at least one of the first recording method and the second recording method is designated by one of a threshold for determining whether to store data, a time interval at which data is stored, and a resolution.

14. The medium according to claim 11, the method further comprising temporarily storing the sensor data selected for each of the sensors in a second temporary storage unit until the sensor data reaches a minimum recording unit of the sensor data storage unit.

15. The medium according to claim 11, wherein the sensor data storage unit includes a plurality of recording areas for the respective sensors.
